(19) United States
(12) Patent Application Publication
(10) Pub. No.: US 2019/0163850 A1
(43) Pub. Date: May 30, 2019

(54) SYSTEM CONFIGURED TO CHANGE THE MACH NUMBER FOR DIFFERENT ANGLES OF ATTACK WITH DIFFERENT SPEEDS FOR ACHIEVING CHANGING AERODYNAMIC FORCES AND VELOCITY WITH A DECELERATION DEVICE INTEGRATED WITH A BLUNT BODY

(71) Applicant: Khaled Abdullah Alhussan, Riyadh (SA)

(72) Inventor: Khaled Abdullah Alhussan, Riyadh (SA)

(21) Appl. No.: 16/204,154

(22) Filed: Nov. 29, 2018

Related U.S. Application Data
(60) Provisional application No. 62/592,096, filed on Nov. 29, 2017.

(51) Int. Cl. G06F 17/50; G06F 17/10

(52) U.S. Cl. CPC G06F 17/5009; G06F 17/10; F15D 1/10; G06F 2217/16; G06F 17/5086

(57) ABSTRACT

A system to change a Mach number for different angles of attack with different speeds to achieving changing aerodynamic forces and velocity with a deceleration device integrated with a blunt body, the system includes a blunt body model having a deceleration device integrated into the blunt body model; a computational fluid dynamic module to perform data analysis on the blunt body model as the blunt body model receives fluid flow; a selection of Mach numbers to be inputted into the computational fluid dynamics module; a selection of angles of attack to be inputted into the computational fluid dynamics module; and contoured plots created via the computational fluid dynamics; the contoured plots relates to fluid flow around the blunt body model, with the contoured plots providing data relating to one or more of the selection of Mach numbers and one or more of the selection of angles of attack; and the contoured plots provides data analysis to be used to develop a design of a blunt body with optimal performance.

### BACKGROUND

### 1. Field of the Invention

The present invention relates generally to methods and systems for improving designs of bodies moving through a fluid medium, and more specifically, to a system configured to change the Mach number for different angles of attacks with different speeds for achieving changing aerodynamic forces and velocity with a deceleration device integrated with a blunt body.

### 2. Description of Related Art

Methods and systems for improving designs associated with bodies moving through a fluid medium are common in the art and involve the use of computational fluid dynamics (CFD). These methods and systems rely on numerical analysis and data structures to evaluate fluid flows. It is important to understand that these methods and systems provide analysis relating to the effects of aerodynamic drag on a body, the results then being used to improve designs, such as the surface structure of the body.

One of the problems associated with conventional methods and systems for improving designs associated with bodies moving through a fluid medium is the inadequate evaluation of the incorporation of deceleration devices into a blunt body. The evaluation of such a design modification is important as the fluid flow structure will be subject to sever change of aerodynamic forces and velocity based on the added deceleration device.

Accordingly, although great strides have been made in the area of systems for improving blunt body designs, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a simplified side view of a blunt body with a deceleration device at an attack angle of 0 degrees in accordance with a system configured to change the Mach number for different angles of attacks with different speeds for achieving changing aerodynamic forces and velocity;

FIG. 2 is a simplified side view of the blunt body of FIG. 1 at an angle of attack greater than 0 degrees;

FIG. 3 is a plot of the fluid flow associated with the blunt body of FIG. 1;

FIG. 4 is a plot of the fluid flow associated with the blunt body of FIG. 2; and

FIG. 5 is a flowchart of the analysis of the blunt body of FIGS. 1 and 2.

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional systems for improving blunt body designs. Specifically, the present invention provides a system for the analysis of changing of the Mach number and angle of attack on the fluid flow and aerodynamics of a blunt body having a deceleration device integrated therein. These and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

Referring now to the drawings wherein like reference characters identify corresponding or similar elements throughout the several views, FIGS. 1-4 depict various simplified views of a system for changing the Mach number for different angles of attack with different speeds for achieving changing aerodynamic forces and velocity with a deceleration device integrated with a blunt body. It will be appreciated that the system of the present invention overcomes one or more of the above-listed problems commonly associated with systems for improving blunt body designs.

In the contemplated embodiment, the system includes computational fluid dynamic analysis of a model of a blunt body 109 having a blunt end 110 and a deceleration device 111 integrated into the body, wherein the computational fluid dynamic analysis is configured to provide data relating to fluid flow 113 in regard to changes in Mach number and including various angles of attack, thereby altering the aerodynamic forces and velocity associated with body 109. The computational fluid dynamic analysis provides a means to develop a design methodology so as to predict optimal performance associated with a blunt body.

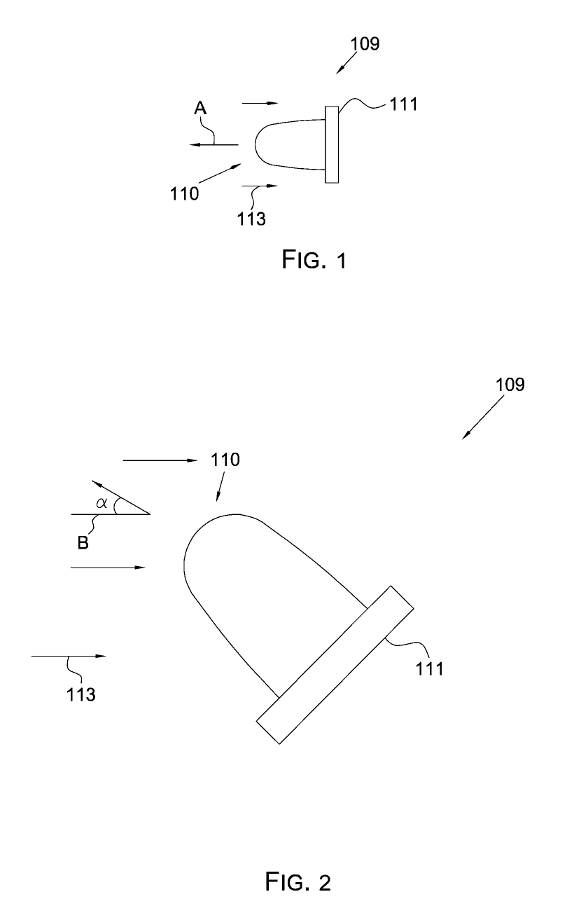

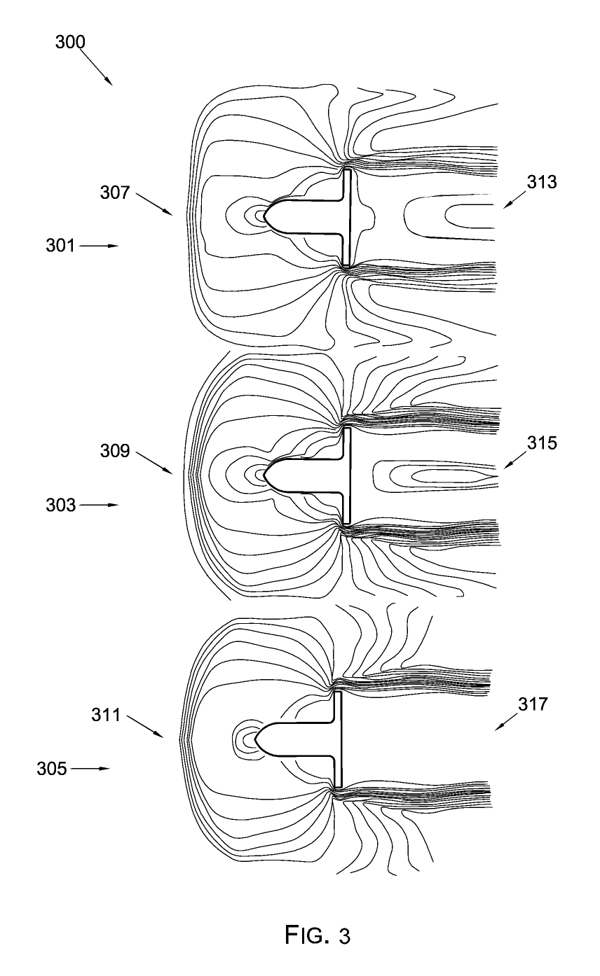

As shown in FIGS. 1 and 2, the computational fluid dynamic analysis evaluates a simulation of body 109 at a Zero angle of attack (A) (FIG. 1) and at a greater than zero angle of attack (B) (FIG. 2). In the preferred application, angles between 0 and 15 degrees are used to evaluate fluid flow 113 over body 109 and the effect of said varying angles on the aerodynamics of the blunt body.

In the preferred embodiment, the analysis of fluid flow over body 109 is further conducted at various Mach number values, thereby providing additional fluid flow analysis as it relates to a blunt body with a deceleration device attached thereon. It should be understood that the use of varying Mach numbers aids in the analysis of the overall effect of the incorporation of the deceleration device. In the preferred embodiment, the range of Mach numbers is between 1.2 and 3.0, however, it is contemplated that the range can be altered as desired for analysis.

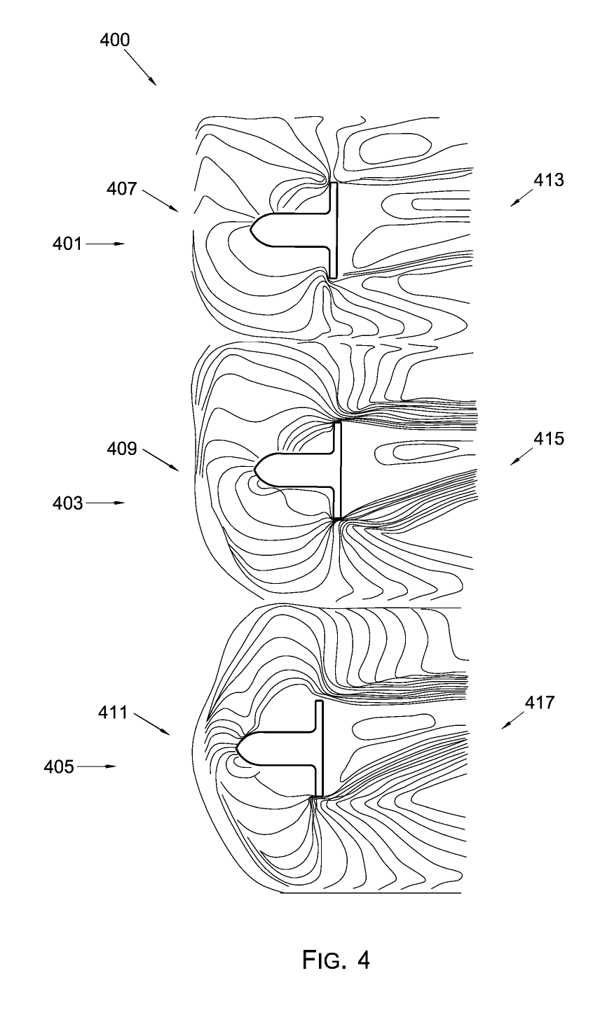

In FIG. 3, a simplified schematic 300 demonstrates fluid flow about body 109 at three Mach numbers, increasing from trial 301 to 303, to 305, and at a zero angle of attack. As shown in this figure, it is determined that shape and strength of detached shock waves 307, 309, 311 associated with each trial changes with increasing Mach number. It is further shown in this trail that flow separation 313, 315, 317 changes with changing in Mach number. The analysis provided herein provides data for the design of an optimal performance blunt body with a deceleration device.

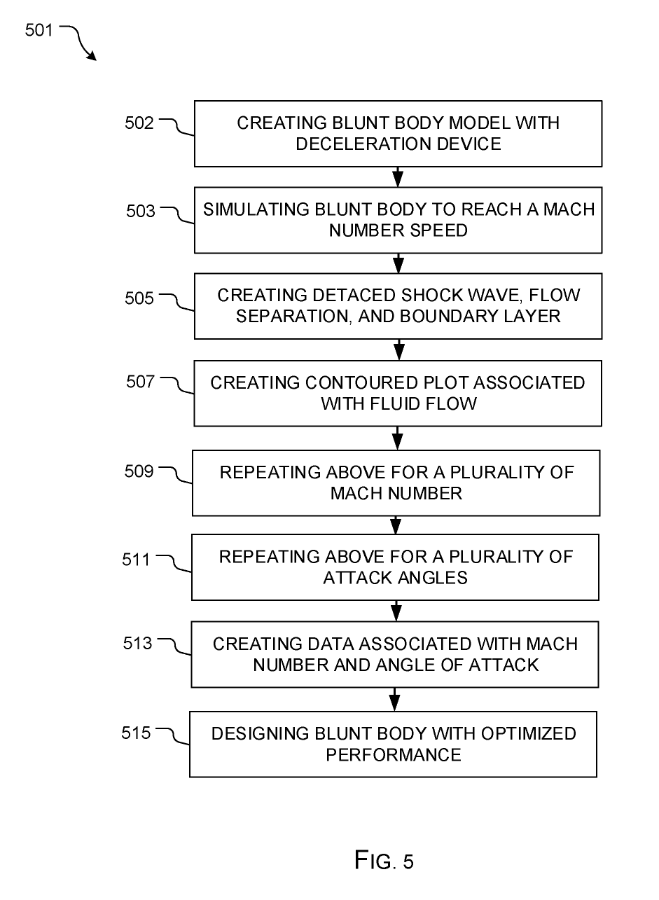

In FIG. 4, a simplified schematic 400 demonstrates fluid flow about body 109 at three Mach numbers, increasing from trial 401, to 403, to 405, and at a 15 degree angle of attack. This figure further demonstrates a change in shape and strength of detached shock waves 407, 409, 411 associated with increasing Mach number in addition to changes in flow separation 413, 415, 417 with each trial. It should be appreciated that this analysis provides additional data for the design of an optimal performance blunt body with a deceleration device.

It should be appreciated that one of the unique features believed characteristic of the present application is the analysis of the effects of angle of attack change and Mach number change on a blunt body having a deceleration device. It should be appreciated that this analysis provides for a means to develop a design methodology so as to predict optimal performance of a blunt body having a deceleration device secured thereon.

In FIG. 5, a flowchart 501 depicts the analysis associated with fluid flow about a blunt body having a deceleration device secured thereon in relation to changes in the Mach number and angle of attack. A model of a blunt body with a deceleration device is created, as shown with box 502. The blunt body is simulated to reach a velocity of a desired Mach number, wherein fluid flows around the body and creates a detached shock wave, flow separation, and a boundary layer, as shown with boxes 503, 505. A contoured computational plot associated with the fluid flow is created, as shown with box 507. The steps above are repeated for a plurality of Mach numbers, wherein a plurality of contoured plots are thereby developed, as shown with box 509. The entire sequence is subsequently repeated with varying angles of attack simulated, thereby creating data relating to both Mach number and angle of attack, as shown with boxes 511, 513. The data is further used for analysis to design the shape and size of blunt body with the deceleration device as desired for optimal performance of the blunt body, as shown with box 515.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed is:

1. A system configured to change a Mach number for different angles of attack with different speeds to achieving changing aerodynamic forces and velocity with a deceleration device integrated with a blunt body, the system comprising:
a blunt body model having a deceleration device integrated into the blunt body model;
a computational fluid dynamic module configured to perform data analysis on the blunt body model as the blunt body model receives fluid flow;
a selection of Mach numbers configured to be inputted into the computational fluid dynamics module;
a selection of angles of attack configured to be inputted into the computational fluid dynamics module; and
a plurality of contoured plots created via the computational fluid dynamics;
wherein the plurality of contoured plots relates to fluid flow around the blunt body model, with the plurality of contoured plots providing data relating to one or more of the selection of Mach numbers and one or more of the selection of angles of attack; and
wherein the plurality of contoured plots provides data analysis to be used to develop a design of a blunt body with optimal performance.

2. The system of claim 1, wherein the deceleration device is integrated to an end opposite of a blunt end of the blunt body.

3. The system of claim 1, wherein the selection of Mach numbers is a range from 1.2 to 4.0.

4. The system of claim 1, wherein the selection of angles of attack is a range of 0 degrees to 15 degrees.

5. The system of claim 1, wherein the plurality of contoured plots comprises:
a visual representation of detached shock waves associated with the blunt body model movement through fluid; and
a visual representation of flow separation associated with the blunt body model movement through fluid.

6. A method for creating a blunt body with optimized performance, the method comprising:
creating a blunt body model with a deceleration device incorporated into the blunt body model;
implementing analysis on the blunt body model through use of a computational fluid dynamics module, wherein the analysis is based on fluid flow around the blunt body model;
selecting a Mach number from a selection of Mach numbers associated with movement of the blunt body model through fluid;
selecting an angle of attack from a selection of angles of attack associated with movement of the blunt body model through fluid;
developing a plurality contoured plots associated with fluid flow around the blunt body model, wherein the plurality of contoured plots provide data relating to the changes in Mach number and angle of attack; and
analyzing the plurality of contoured plots to determine data to implement in building an optimized blunt body.

7. The method of claim 6, wherein the selection of Mach numbers is a range from 1.2 to 4.0.

8. The method of claim 6, wherein the selection of angles of attack is a range of 0 degrees to 15 degrees.

9. The method of claim 6, wherein the plurality of contoured plots comprises:
a visual representation of detached shock waves associated with the blunt body model movement through fluid; and
a visual representation of flow separation associated with the blunt body model movement through fluid.
